(19) United States
(12) Patent Application Publication
(10) Pub. No.: US 2013/0257107 A1
(43) Pub. Date: Oct. 3, 2013

(54) Wiper Blade for a Window Wiper of a Motor Vehicle and Window Arrangement for a Motor Vehicle

(71) Applicants: Andreas Zygan, Malsch (DE); Uwe Renz, Filderstadt-Harthausen (DE); Christina Nestler, Ostelsheim (DE); Alexander Mittler, Sindelfingen (DE)

(72) Inventors: Andreas Zygan, Malsch (DE); Uwe Renz, Filderstadt-Harthausen (DE); Christina Nestler, Ostelsheim (DE); Alexander Mittler, Sindelfingen (DE)

(73) Assignee: DAIMLER AG, Stuttgart (DE)

(21) Appl. No.: 13/883,507

(22) PCT Filed: Oct. 19, 2011
(86) PCT No.: PCT/EP2011/005258

§ 371 Date: Jun. 21, 2013

(30) Foreign Application Priority Data
Nov. 5, 2010 (DE) 10 2010 050 610.9

(51) Int. Cl. B60S 1/38; B60J 10/00

(52) U.S. Cl. CPC B60S 1/38; B60J 10/0045
USPC 296/208; 15/250.361

(57) ABSTRACT

A wiper blade for a windscreen wiper of a motor vehicle includes a clamp for fixing a wiping element that wipes the screen during the wiping operation of the windscreen wiper. The clamp has a base plate with at least one contact element. The contact element is to be brought against a water deflector that restricts the wiping movement of the wiper blade during the wiping operation. The contact element is a cushioning element, which has a higher level of flexibility than the base plate.

### BACKGROUND AND SUMMARY OF THE INVENTION

Exemplary embodiments of the present invention relate to a wiper blade for a windscreen wiper of a motor vehicle, having a clamp for fixing a wiping element that wipes the screen during the wiping operation of the windscreen wiper, wherein the clamp has a base plate with at least one contact element, which is to be brought against an element on the vehicle side that restricts the wiping movement of the wiper blade. Furthermore, the invention relates to a windscreen arrangement for a motor vehicle.

German Patent Publication DE 10 2006 004 109 A1 describes a wiping device with an activatable wiper arm and with a wiper blade arranged on the wiper arm. The wiper blade comprises a moulded part made from metal or plastic, which encompasses a blade rubber and spring strips of the wiper blade. A pin is designed integrally with the moulded part, which protrudes from a base plate of the molded part set up at an angle to the screen. A ramp-like element is arranged on the screen in the region of a resting position of the wiper blade. When the wiper blade reaches the resting position, the pin surges up to the ramp-like element and raises a wiper lip of the blade rubber from the screen. The wiper lip is pressure-relieved in this way and is subject to less deterioration.

German Patent Publication DE 199 52 251 A1 also describes a relief device for a windscreen wiper of a motor vehicle. A slide rail is arranged on the wiper blade via a connecting piece, which is set up in the direction of a resting position of the wiper blade, pointing towards and at an angle to the screen that is to be wiped. A tapered formation is provided in the region of a radiator tank cover of the vehicle, the cross-section of which is decreased in the direction going towards the screen. If the wiper blade is moved into the resting position, the slide rail slides the ramp-like formation upwards, thereby ensuring that a wiper lip of the blade rubber is raised by the screen.

German Patent Publication DE 60 2004 011 013 T2 describes a wiper arm that is designed as a grooved profile. A wiper blade runs along an internal side of the grooved profile. A protrusion is designed on an arm of the grooved profile, against which the wiper arm rests on a windscreen pillar of the motor vehicle in a resting position. A defined alignment of the wiper arm is predetermined in the resting position. This is supported by the fact that the wiper arm stands in its resting position under pre-stressed conditions and therefore presses against the windscreen pillar.

It is disadvantageous if the wiper blade or wiper arm strikes an element that restricts the movement of the wiper blade on the vehicle side, which can lead to damage.

Exemplary embodiments of the present invention are directed to an improved wiper blade and an improved windscreen arrangement for a motor vehicle.

The wiper blade according to the invention for a windscreen wiper of a motor vehicle comprises a clamp for fixing a wiping element that wipes the screen during the wiping operation of the windscreen wiper. The clamp has a base plate with at least one contact element, which can be brought against an element that restricts the wiping movement of the wiper blade on the vehicle side. The at least one contact element is hereby designed as a cushioning element, which has a higher level of flexibility than the base plate. In this way, when the contact element is brought against the element that restricts the wiping movement of the wiper blade on the vehicle side, it does not lead to hard contact, but rather only a softened, weak contact. This prevents the wiper blade or vehicle-side element from being damaged. Additionally, in an advantageous manner, the contact is essentially inaudible for a vehicle passenger, such that the contact element being brought against the vehicle-side element does not cause any discomfort for the passenger.

Furthermore, during the wiping operation, a particularly small gap between the wiper blade and the vehicle-side element can be provided. If, during the wiping operation, the wiper blade moves towards the element that restricts the wiping movement on the vehicle side, and rainwater and/or washer fluid is conveyed to the vehicle-side element, by reversing the wiper blade, this leads to water located on the screen being withdrawn. The smaller the gap is, which is present between the wiper blade located in its return position and the vehicle-side element, the smaller the amount of water is that is withdrawn back from the wiper blade.

The gap that is typically to be provided between the wiper blade in its return position and the vehicle-side element, due to production and assembly tolerances of the wiper system, wiper arm and wiper blade, can also be kept particularly low in the present case. This leads to a clear reduction, which is perceptible to the vehicle passenger, of the amount of water and/or washer fluid withdrawn during the wiping operation and thus to an improved view through the windscreen for the passenger.

Due to the flexible cushioning element, the wiper blade can strike the vehicle-side element during the wiping operation, without this leading to the wiper blade or vehicle-side element being damaged. This is also accompanied by a particularly long lifetime for the wiper blade.

Furthermore, when the gap between the wiper blade and the vehicle-side element during the wiping operation is particularly low, in particular reduced to nothing, a particularly large amount of water is displaced via the vehicle-side element and thus removed from the screen. This also leads to the passenger having a particularly good view through the windscreen when the windscreen wiper is in the wiping operating and water and/or washer fluid is being wiped from the windscreen. Reducing the withdrawal of water by the wiper blade, which is also called water pullback, can also, in particular, go to such an extent that there is no more withdrawn water present in the main field of sight, which is also called the field of vision according to ECE Regulation R43.

In an advantageous embodiment of the invention, the cushioning element is designed as a protrusion that is projected in a movement direction towards an upper return position of the wiper blade above the base plate. The deformation of the flexible protrusion can then cushion the movement of the wiper blade moving towards its upper return position to such an extent that the base plate of the wiper blade can be brought against the vehicle-side element.

In a further advantageous embodiment of the invention, the cushioning element is designed as a lip, which is formed from a material that is softer than the base plate. The lip is then easily deformed when the wiper blade is moved towards the element that restricts the wiping movement on the vehicle side, and then the lip comes into contact with the vehicle-side element.

Additionally or alternatively, the cushioning element can be designed as a hollow chamber. Also, such a cushioning element also ensures effective cushioning of the contact between the wiper blade and the vehicle-side element. Additionally, such a cushioning element can be produced in a particularly simple manner.

In a further advantageous embodiment of the invention, a wall of the cushioning element is designed as a rolling lobe or a bellows. Such a cushioning element is also cost-effective and can be provided simply, and can have its properties easily adjusted to the desired cushioning effect.

The cushioning element can also comprise a foam material so as to ensure soft contact between the wiper blade and the vehicle-side element.

In a further advantageous embodiment of the invention, the cushioning element has a back section with a plurality of pins sticking out from the back section. Due to the fact that the pins yield in a particularly effective manner, this cushioning element, designed in the form of a brush or a comb, enables the movement of the wiper blade that is to be moved towards the vehicle-side element to be cushioned and thereby decelerated.

It is furthermore preferable if a base plate of the clamp is designed integrally with the cushioning element. Thus a particularly cost-effective production of the wiper blade can be carried out.

According to a further advantageous embodiment of the invention, if the clamp is formed from a plastic, this is particularly cost-effective and at the same time has sufficient dimensional stability.

A multi-component injection molding process can be used to form the cushioning element integrally with the base plate of the clamp. However, the cushioning element can also be injected onto the base plate at a later point in time if an injection molding process is used.

If the clamp is designed as an end cap for the wiper blade, this can, in any case, typically be extended in terms of its functionality to the components provided on the wiper blade in a typically purposeful manner, in order to provide the cushioning element. In particular, the end cap can fix a spring element and/or an air conveyance element of the wiper blade. The base plate of the end cap is then sufficiently hard to enable the respective components of the wiper blade to be fixed, while the shaped, soft cushioning element ensures that the contact between the wiper blade and the vehicle-side element is soft.

It has hereby been shown to be advantageous if the end cap is arranged on one end of the wiper blade, which is far from a rotational axis of the wiper arm when there is a wiper blade arranged on a wiper arm. Then the end cap is located at the end of the wiper blade that has the further movement path during the wiping operation and thus has a higher level of movement speed. Here, it is also most important to anticipate the contact element striking the vehicle-side element.

According to a further aspect of the invention, it is also possible for the cushioning element presently arranged on the wiper blade to be formed on a wiper arm of the windscreen wiper and/or on a connecting section, via which the wiper blade can be coupled to the wiper arm.

The windscreen arrangement for a motor vehicle according to the invention comprises a water circuit arrangement, which is arranged on a windscreen pillar that borders a windscreen of the motor vehicle. The water circuit arrangement comprises a base plate and at least one cushioning element arranged on the base plate, which is to be brought against a wiper blade of the windscreen wiper during the wiping operation of the windscreen wiper, and which has greater flexibility than the base plate.

By providing the cushioning element on the water circuit apparatus, the wiper blade can be cushioned on this during the wiping operation and strike without a striking noise occurring, such that a minimal gap remains between the wiper blade and the water circuit apparatus, if necessary. The cushioning element can even be designed in such a way that the wiper blade is to be brought against the water circuit apparatus at least considerably and in particular completely, when it impacts the water circuit apparatus during the wiping operation.

If there is a particularly small gap between the wiper blade and the water circuit apparatus, the wiper blade hardly drags any water and/or washer fluid with it while the water circuit apparatus is moving away. In fact, a particularly large amount of water or washer fluid is pushed outwards over the water circuit apparatus and discharged. An improved windscreen arrangement is thereby created.

For the windscreen arrangement, it has been shown to be advantageous if the water circuit arrangement comprises a channel, by means of which water fed from the wiper blade to this channel is to be collected during the wiping operation of the windscreen wiper. In this way, the water pushed from the wiper blade to the water circuit apparatus can be discharged in a particularly good and targeted manner.

The advantages and preferred embodiments described for the wiper blade with the cushioning element, in particular the embodiment possibilities for the cushioning element itself, also apply for the windscreen arrangement whose water circuit apparatus has the cushioning element. Also, both the wiper blade and/or the wiper arm, as well as the water circuit apparatus, can have the cushioning element.

The features and feature combinations cited in the description above and the features and feature combinations cited below in the description of the figures and/or shown in the figures alone can be used not only in each specified combination, but rather also in other combinations or individually, without exceeding the scope of the invention.

### BRIEF DESCRIPTION OF THE DRAWING FIGURES

Further advantages, features and details of the invention arise from the claims, the description of preferred embodiments below and with the aid of the figures. The following are shown:

FIG. 1 a cross-section through a wiper blade located on a front windscreen of a motor vehicle in the region of an end cap of the same, wherein the end cap is brought against a water deflector that is designed on a windscreen pillar of the motor vehicle; and

FIG. 2 a section through the wiper blade in the region of its end cap.

### DETAILED DESCRIPTION

A wiper blade 10 has a blade rubber 12, whose wiper lip 14 wipes a front windscreen 16 of a motor vehicle during the wiping operation of a windscreen wiper (not shown). The wiper blade 10 has an end cap 18 on its upper end (shown), which serves as a clamp for the blade rubber 12. The end cap 18 is thus located on the end of the wiper blade 10, which moves as fast as it can during the wiping of the front windscreen 16.

A base plate 20 of the end cap 18 is designed in the form of a fastener and is made from a hard plastic. The base plate 20 has an inner arm 22 and an outer arm 24. During the wiping operation, the outer arm 24 approaches a water deflector 26, which is arranged on a windscreen pillar of the motor vehicle which borders the front windscreen 16 on one side. The water deflector 26 is presently shown, for example, for a vehicle-side element of a windscreen arrangement of the motor vehicle that restricts the wiping movement of the wiper blade 10 during the wiping operation. In alternative embodiments, the wiper blade 10 can be brought against a vehicle-side element that is set up differently during the wiping operation.

The water deflector 26 presently forms a channel 28, in which water, which the blade rubber 12 feeds to the channel 28, collects, when the wiper blade 10 moves to its upper return position. Excess water that cannot be contained by the channel 28 is hereby pushed outwards above the water deflector 26, so in the direction of the windscreen pillar (not shown) and thus removed from the front windscreen 16.

A cushioning element 30 is injected onto the outer arm 24 of the base plate 20 of the end cap 18, which is alongside the water deflector 26 in the return position of the wiper blade 10, the cushioning element having greater flexibility than the base plate 20.

The cushioning element 30 is, in the presently shown exemplary embodiment, designed as a hollow chamber, which is deformed when the wiper blade 10 surges onto the water deflector 26. Due to the cushioning element 30 that forms soft contact, it is possible to permit the wiper blade 10 to strike the water deflector 26 during the wiping operation of the windscreen wiper, without this leading to the wiper blade 10 being damaged or to there being an audible contact noise.

Also, the water deflector 26 is not damaged by the contact of the wiper blade 10. Thus a minimal gap between the blade rubber 12 and the water deflector 26 can be achieved during the wiping operation, which leads to a particularly small amount of water remaining on the front windscreen 16. Accordingly, the water pullback, so the pulling or withdrawing of water during the downward movement of the wiper blade 10 from the upper return position to the lower return position, is also particularly low. This leads to the vehicle passenger having an improved view through the front windscreen 16.

Due to the construction of the cushioning element 30 being that of a hollow chamber, the wiper blade can be moved so close to the water deflector 26 that the outer arm 24 of the base plate 20 is almost completely moved towards the water separator 26.

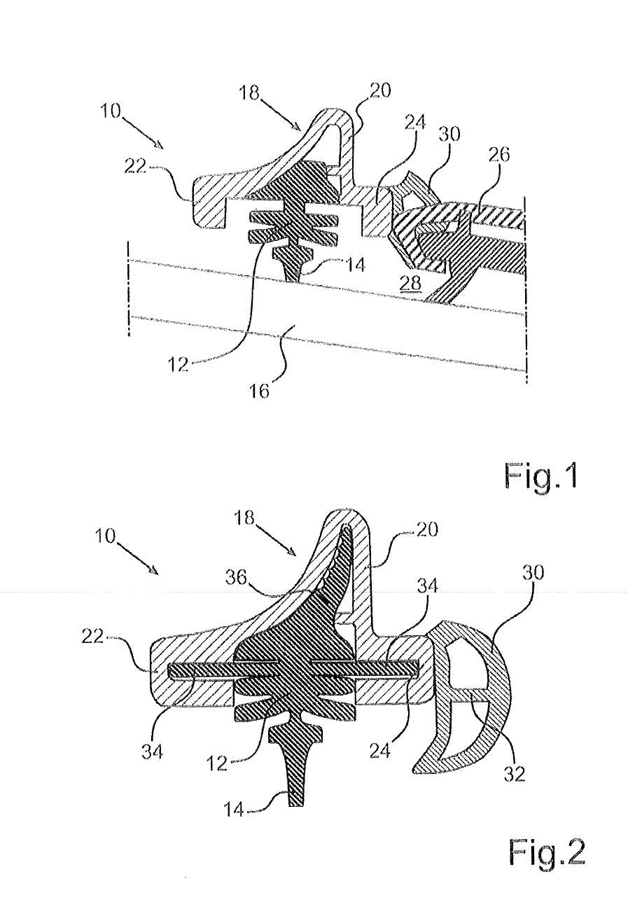

FIG. 2 shows the wiper blade 10 with the non-deformed cushioning element 30, so in a state before it has impacted the water deflector 26 shown in FIG. 1. A hollow space in the cushioning element 30 is divided by a bar 32 and the cushioning element 30 has a convex outer side, i.e. curved towards the water deflector 26.

FIG. 2 illustrates further elements fixed by the end cap 18 of the wiper blade 10, which include spring strips 34 and an air conveyance element in the form of a spoiler 36.

In the place of the cushioning element 30 that is designed, for example, as a hollow chamber, this can also be designed as a soft lip, a damper or a foam body.

Alternatively, a concertina structure, roughly in the shape of a rolling lobe or a bellows, can be provided as a cushioning element, or indeed a comb-shaped cushioning element can be provided, which has pins or prongs protruding towards the water deflector 26.

Additionally or alternatively to its arrangement on the wiper blade 10, the cushioning element 30 can also be arranged on the water deflector 26.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A wiper blade for a windscreen wiper of a motor vehicle, the wiper blade comprising:
a wiping element configured to wipe the windscreen during a wiping operation of the windscreen wiper;
a clamp configured to secure the wiping element, wherein the clamp has a base plate with at least one contact element, which is configured to be brought against a vehicle-side element that restricts a wiping movement of the wiper blade,
wherein the at least one contact element is configured as a cushioning element that has greater flexibility than the base plate.

12. The wiper blade according to claim 11, wherein the cushioning element is a protrusion that is projected in a movement direction towards an upper return position of the wiper blade above the base plate.

13. The wiper blade according to claim 11, wherein the cushioning element is configured as a lip formed from a softer material than the base plate.

14. The wiper blade according to claim 11, wherein the cushioning element is configured as a hollow chamber.

15. The wiper blade according to claim 11, wherein one wall of the cushioning element is configured as a rolling lobe or a bellows.

16. The wiper blade according to claim 11, wherein the cushioning element has a back section with a plurality of pins sticking out from the back section.

17. The wiper blade according to claim 11, wherein the base plate of the clamp is configured integrally with the cushioning element.

18. The wiper blade according to claim 11, wherein the clamp is an end cap of the wiper blade, which secures a spring element or an air conveyance element of the wiper blade.

19. The wiper blade according to claim 18, wherein the end cap is arranged at one end of the wiper blade, which is far from a rotational axis of the wiper arm when the wiper blade arranged on a wiper arm.

20. A windscreen arrangement for a motor vehicle, comprising:
a water circuit apparatus arranged on a windscreen pillar of the motor vehicle that borders a windscreen of the motor vehicle,
wherein the water circuit apparatus has a base plate and at least one cushioning element arranged on the base plate, which is to be brought against a wiper blade of a windscreen wiper during the wiping operation of a windscreen, and which has greater flexibility than the base plate.
